(19) United States
(12) Patent Application Publication
(10) Pub. No.: US 2008/0266438 A1
(43) Pub. Date: Oct. 30, 2008

(54) DIGITAL CAMERA AND METHOD OF OPERATION

(76) Inventor: Henrik Eliasson, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/741,795

(22) Filed: Apr. 30, 2007

(51) Int. Cl. H04M 1/00; H04N 5/222

(52) U.S. Cl. 348/333.01; 455/560; 348/E05.022

(57) ABSTRACT

A camera assembly and a method of camera assembly operation that separately establish camera settings for electronic viewfinder operation and for image capture operation. Further, the camera assembly may be operated in a viewfinder mode using the camera settings for the electronic viewfinder operation and, in response to an input command to take a photograph, the camera assembly may capture an image using the camera settings for the image capture operation.

### TECHNICAL FIELD OF THE INVENTION

The technology of the present disclosure relates generally to photography and, more particularly, to a system and method to optimize performance of electronic viewfinder operation and image capture operation.

### DESCRIPTION OF THE RELATED ART

A digital camera may include an electronic viewfinder to display a dynamically updated representation of the field of view of the camera to a user. The electronic viewfinder is often configured as a display that operates in an electronic viewfinder mode to display “draft” images of the field of view that are captured by a sensor. The sensor is also used to image a scene to create a photograph in the form of a picture file for storage in a memory of the camera. The picture file contains a representation of the field of view of the camera at the time that the photograph was taken. Depending on the lighting conditions associated with the scene, certain camera settings may be adjusted to maximize quality of the image. These camera settings include exposure time, sensor sensitivity, aperture setting (if not fixed) and flash usage.

In low light situations, a typical approach to achieve reasonable image quality is to increase the sensitivity of the sensor. Increasing the sensitivity of the sensor runs the risk of increasing noise. Another approach is to increase exposure time, which may reduce the risk of image noise but increases the risk of motion blur. Most camera designers have favored using low sensor sensitivity and long exposure times for low light imaging situations. These settings are used for both imaging of the scene and for the generation of the content for the electronic viewfinder. But the combination of low sensor sensitivity and long exposure time leads to slow responsiveness of viewfinder operation. For instance, the viewfinder may not react quickly to movement of the camera and to motion in the scene. Many users may consider this viewfinder operation to be undesirable.

Some cameras may use a “slow-sync flash.” The slow-sync flash may be activated when the scene luminance is below a predetermined threshold. Below this threshold, the flash may be turned on and the sensor sensitivity, exposure time, and aperture size are set to constant (or fixed) values in a combination to optimize the slow-sync flash image for the particular scene. This combination of camera settings uses light from the scene to contribute to the overall image and illuminates foreground items (especially persons) with the flash. Similar to the above, the fixed sensor sensitivity and aperture settings are used for the generation of the content for the viewfinder. Keeping the same settings for the generation of the content for the viewfinder as for the captured image, may lead to sluggish responsiveness of the viewfinder or noisy viewfinder content.

### SUMMARY

To improve viewfinder operation, there is a need in the art for an improved camera assembly and method of operating a camera assembly. In one embodiment, a camera assembly separately establishes camera settings for electronic viewfinder operation and for image capture operation. In one embodiment, a method of camera operation separately establishes camera settings for electronic viewfinder operation and image capture operation. Further, the camera assembly may be operated in a viewfinder mode using the camera settings for the electronic viewfinder operation and, in response to an input command to take a photograph, the camera assembly may capture an image using the camera settings for the image capture operation.

According to one aspect of the invention, a method of operating a camera assembly includes (a) establishing camera settings for viewfinder operation and displaying a dynamically updated representation of a field of view of the camera assembly by imaging the field of view using the camera settings for viewfinder operation; (b) establishing separate camera settings for image capture operation; and (c) in response to an input command to take a photograph, switching from the camera settings for viewfinder operation to the camera settings for image capture operation and capturing an image.

According to one embodiment of the method, the camera settings for viewfinder operation are established using a first logical routine and the camera settings for image capture operation are established using a second logical routine that is executed separately from the first logical routine.

According to one embodiment, the method further includes sensing luminance of at least a portion of the field of view and, if the luminance is less than a predetermined threshold, the camera settings for the image capture operation are established to include at least one of a fixed sensor sensitivity or a fixed aperture setting, and use of a flash.

According to one embodiment, the method further includes sensing luminance of at least a portion of the field of view and conducting (a) and (b) if the luminance corresponds to a low light situation, otherwise establishing camera settings used for both viewfinder operation and image capture operation.

According to one embodiment of the method, (a) and (b) are carried out in a predetermined operational mode of the camera assembly and, for another operational mode of the camera assembly, establishing camera settings used for both viewfinder operation and image capture operation.

According to one embodiment of the method, the camera assembly is part of a mobile telephone.

According to one embodiment of the method, the camera settings include at least one of exposure time, sensor sensitivity, aperture size or flash operation.

According to another aspect of the invention, a program for operating a camera assembly is stored by a machine readable medium and the program includes code that forms a first logical routine that, when executed, establishes camera settings for viewfinder operation; and code that forms a second logical routine separately executable from the first logical routine and that, when executed, establishes camera settings for image capture operation.

According to one embodiment, the program further includes code that controls the camera assembly to display a dynamically updated representation of a field of view of the camera assembly by imaging the field of view using the camera settings for viewfinder operation; and code that controls the camera assembly to capture an image using the camera settings for image capture operation in response to an input command to take a photograph.

According to one embodiment of the program, if sensed luminance of at least a portion of the field of view is less than a predetermined threshold, the second logical routine establishes camera settings for the image capture operation to include at least one of a fixed sensor sensitivity or a fixed aperture setting, and use of a flash.

According to one embodiment of the program, the first and second logical routines are executed when a sensed luminance of at least a portion of the field of view corresponds to a low light situation, otherwise code that establishes camera settings used for both viewfinder operation and image capture operation is executed.

According to one embodiment of the program, the first and second logical routines are executed when the camera assembly is in a predetermined operational mode and, for another operational mode of the camera assembly, code that establishes camera settings used for both viewfinder operation and image capture operation is executed.

According to one embodiment of the program, the camera assembly is part of a mobile telephone.

According to one embodiment of the program, the camera settings include at least one of exposure time, sensor sensitivity, aperture size or flash operation.

According to another aspect of the invention, a camera assembly includes a sensor for imaging a portion of a scene falling within a field of view of the camera assembly; a light meter for determining luminance of at least a portion of the field of view; an electronic viewfinder that displays a dynamically updated representation of the field of view as detected by the sensor; and a controller that sets at least one camera setting for use in capturing the representation of the field of view for display by the electronic viewfinder and that changes the camera setting to capture an image of the field of view in response to an input command to take a photograph.

According to one embodiment of the camera assembly, the camera setting for viewfinder operation is established using a first logical routine executed by the controller and the camera setting for image capture is established using a second logical routine that is executed by the controller separately from the first logical routine.

According to one embodiment of the camera assembly, the camera settings include at least one of exposure time, sensor sensitivity, aperture size or flash operation.

According to one embodiment, the camera assembly further includes a flash and the controller activates the flash and fixes at least one of sensor sensitivity or aperture size for image capture when the sensed luminance is less than a predetermined threshold.

According to another aspect of the invention, a mobile telephone includes the above-described camera assembly and call circuitry for establishing a call over a network.

These and further features will be apparent with reference to the following description and attached drawings. In the description and drawings, particular embodiments have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIGS. 1 and 2 are respectively a schematic front view and a schematic rear view of a mobile telephone that includes a camera assembly;

FIG. 3 is a schematic block diagram of portions of the mobile telephone and the camera assembly of FIGS. 1 and 2;

FIG. 4 is a schematic diagram of a communications system in which the mobile telephone may operate; and

FIG. 5 is a flow diagram of a method of operating the camera assembly.

### DETAILED DESCRIPTION OF EMBODIMENTS

Embodiments will now be described with reference to the drawings, wherein like reference numerals are used to refer to like elements throughout. It will be understood that the figures are not necessarily to scale.

Aspects of this disclosure relate to photography. The techniques described herein may be applied to taking photographs with a camera, such as a digital still camera. Also, the techniques described herein may be carried out by any type of electronic device that includes a suitably configured camera. For instance, a dedicated digital still camera and/or a digital video camera may be constructed as described herein. As another example, many mobile telephones include cameras that may be constructed in accordance with the present description. By way of example, portions of the following description are made in the context of a mobile telephone that includes a camera assembly. However, it will be appreciated that the disclosed techniques have application outside the context of a mobile telephone and may relate to any type of appropriate electronic equipment, examples of which include a dedicated camera, a media player that includes a camera, a gaming device that includes a camera, a computer that includes a camera and so forth.

For purposes of the description herein, the interchangeable terms “electronic equipment” and “electronic device” include portable radio communication equipment. The term “portable radio communication equipment,” which herein after is referred to as a “mobile radio terminal,” includes all equipment such as mobile telephones, pagers, communicators, electronic organizers, personal digital assistants (PDAs), smartphones, portable communication apparatus or the like.

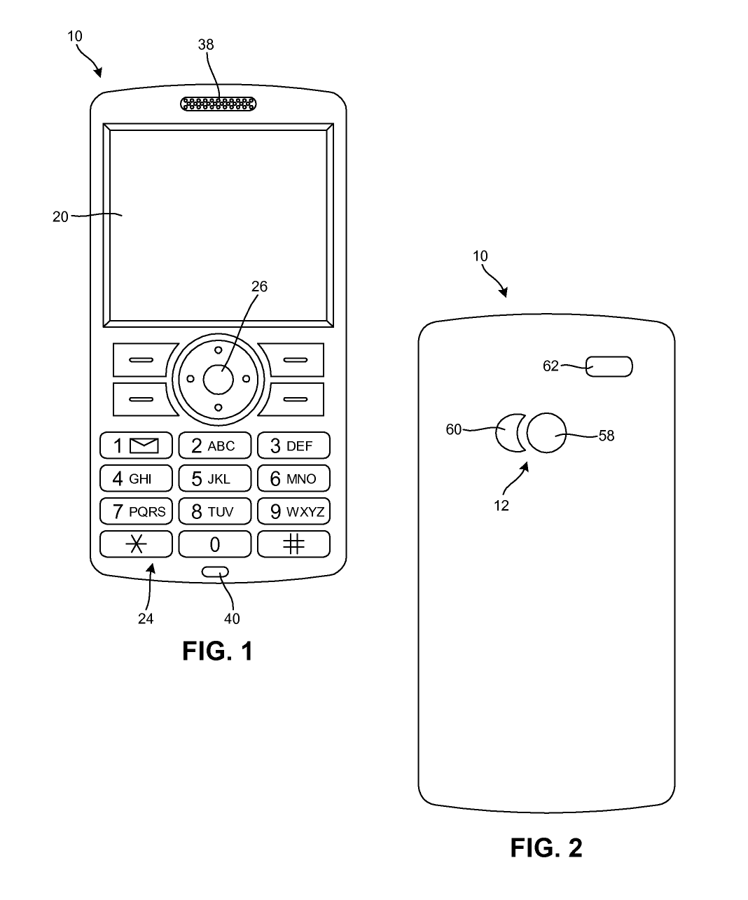

Referring initially to FIGS. 1 through 3, an electronic device 10 is shown. The electronic device 10 includes a camera assembly 12 that is configured to optimize performance of electronic viewfinder operation and image capture operation. Additional details and operation of the camera assembly 12 will be described in greater detail below. The techniques for viewfinder operation and image capture operation may be embodied as executable code that is resident in and executed by the electronic device 10.

In one embodiment, the camera assembly 12 and/or the electronic device 10 may include a controller or processor that executes a camera program 14 stored on a computer or machine readable medium. The camera program 14 may be used to govern overall operation of the camera assembly 12. The camera program 14 may be a stand-alone software application or form a part of a software application that carries out additional tasks related to the electronic device 10.

Furthermore, the camera program 14 may include separately executable routines for viewfinder operation and for image capture operation that are called or activated when certain illumination conditions are sensed. For instance, the camera program 14 may include a viewfinder operation routine 16 and an image capture routine 18. Alternatively, the camera program 14 may be considered a collection of separate programs (e.g., applets) that operate in a cooperative manner to carryout operation of the camera assembly 12.

As indicated, the camera assembly 12 may be embodied as a dedicated camera or as part of a device that performs other functions, such as making telephone calls, playing audio and/or video content, and so forth.

In the illustrated embodiment, the camera assembly 12 is included as part of an electronic device that performs functions in addition to taking photographs. The electronic device of the illustrated embodiment is a mobile telephone and will be referred to as the mobile telephone 10. The mobile telephone 10 is shown as having a “brick” or “block” form factor housing, but it will be appreciated that other housing types may be utilized, such as a “flip-open” form factor (e.g., a “clamshell” housing) or a slide-type form factor (e.g., a “slider” housing).

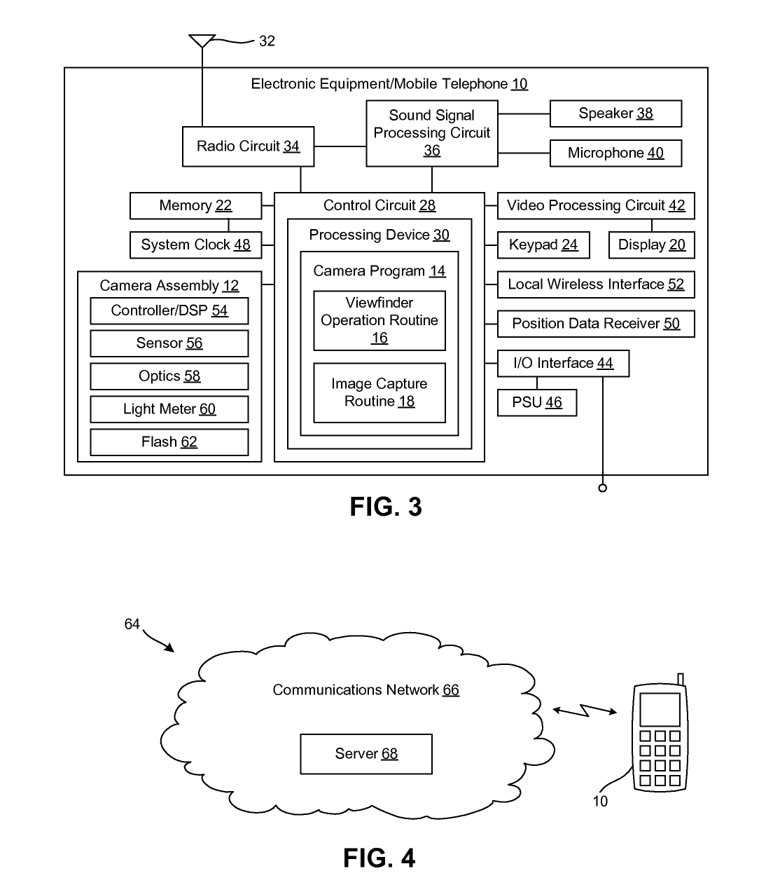

The mobile telephone 10 may include a display 20. The display 20 displays information to a user such as operating state, time, telephone numbers, contact information, various navigational menus, etc., that enable the user to utilize the various features of the mobile telephone 10. The display 20 also may be used to visually display content received by the mobile telephone 10 and/or retrieved from a memory 22 (FIG. 3) of the mobile telephone 10. The display 20 may be used to present images, video and other graphics to the user, such as photographs, mobile television content and video associated with games.

In addition, the display 20 may be used as an electronic viewfinder during operation of the camera assembly 12. In an embodiment where the camera assembly 12 is a dedicated camera, the display 14 may included with the camera assembly 12 to serve as an electronic viewfinder and to display captured images. In addition to an electronic viewfinder, an optical viewfinder may be present.

A keypad 24 provides for a variety of user input operations. For example, the keypad 24 may include alphanumeric keys for allowing entry of alphanumeric information such as telephone numbers, phone lists, contact information, notes, text, etc. In addition, the keypad 24 may include special function keys such as a “call send” key for initiating or answering a call, and a “call end” key for ending or “hanging up” a call. Special function keys also may include menu navigation and select keys to facilitate navigating through a menu displayed on the display 20. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 20. Also, the display 20 and keypad 24 may be used in conjunction with one another to implement soft key functionality.

During operation of the camera assembly 12, one of the keys from the keypad 24 may serve as a shutter release button 26. The user may depress the shutter release button 26 to command the capturing of image using the camera assembly 12.

The mobile telephone 10 includes call circuitry that enables the mobile telephone 10 to establish a call and/or exchange signals with a called/calling device, which typically may be another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The mobile telephone 10 may be configured to transmit, receive and/or process data, such as text messages, instant messages, electronic mail messages, multimedia messages, image files, video files, audio files, ring tones, streaming audio, streaming video, data feeds (including podcasts and really simple syndication (RSS) data feeds), and so forth. It is noted that a text message is commonly referred to by some as “an SMS,” which stands for simple message service. SMS is a typical standard for exchanging text messages. Similarly, a multimedia message is commonly referred to by some as “an MMS,” which stands for multimedia message service. MMS is a typical standard for exchanging multimedia messages. Processing data may include storing the data in the memory 16, executing applications to allow user interaction with the data, displaying video and/or image content associated with the data, outputting audio sounds associated with the data, and so forth.

FIG. 3 represents a functional block diagram of the mobile telephone 10. For the sake of brevity, generally conventional features of the mobile telephone 10 will not be described in great detail. The mobile telephone 10 includes a primary control circuit 28 that is configured to carry out overall control of the functions and operations of the mobile telephone 10. The control circuit 28 may include a processing device 30, such as a CPU, microcontroller or microprocessor. The processing device 30 executes code stored in a memory (not shown) within the control circuit 28 and/or in a separate memory, such as the memory 22, in order to carry out operation of the mobile telephone 10. The memory 22 may be, for example, one or more of a buffer, a flash memory, a hard drive, a removable media, a volatile memory, a non-volatile memory, a random access memory (RAM), or other suitable device. In a typical arrangement, the memory 16 may include a non-volatile memory (e.g., a NAND or NOR architecture flash memory) for long term data storage and a volatile memory that functions as system memory for the control circuit 28. The volatile memory may be a RAM implemented with synchronous dynamic random access memory (SDRAM). The memory 22 may exchange data with the control circuit 28 over a data bus. Accompanying control lines and an address bus between the memory 28 and the control circuit 28 also may be present.

The processing device 30 may execute code that implements the camera program 14, inclusive of the viewfinder operation routine 16 and the image capture routine 18. It will be apparent to a person having ordinary skill in the art of computer programming, and specifically in application programming for mobile telephones, cameras or other electronic devices, how to program a mobile telephone 10 to operate and carry out logical functions associated with the camera program 14. Accordingly, details as to specific programming code have been left out for the sake of brevity. Also, while the camera program 14 is executed by the processing device 20 in accordance with an embodiment, such functionality could also be carried out via dedicated hardware, firmware, software, or combinations thereof. In other embodiments or when the camera assembly 12 is configured as a dedicated camera, the camera program 14 may be executed by a controller (described below) of the camera assembly 12. Furthermore, the camera program 14 may be stored on a machine readable medium, such as the memory 22.

Continuing to refer to FIGS. 1 through 3, the mobile telephone 10 includes an antenna 32 coupled to a radio circuit 34. The radio circuit 34 includes a radio frequency transmitter and receiver for transmitting and receiving signals via the antenna 32 as is conventional. The radio circuit 34 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 10 further includes a sound signal processing circuit 36 for processing audio signals transmitted by and received from the radio circuit 34. Coupled to the sound processing circuit 36 are a speaker 38 and a microphone 40 that enable a user to listen and speak via the mobile telephone 10 as is conventional. The radio circuit 34 and sound processing circuit 36 are each coupled to the control circuit 28 so as to carry out overall operation. Audio data may be passed from the control circuit 28 to the sound signal processing circuit 36 for playback to the user. The audio data may include, for example, audio data from an audio file stored by the memory 22 and retrieved by the control circuit 28, or received audio data such as in the form of streaming audio data from a mobile radio service. The sound processing circuit 36 may include any appropriate buffers, decoders, amplifiers and so forth.

The display 20 may be coupled to the control circuit 28 by a video processing circuit 42 that converts video data to a video signal used to drive the display 20. The video processing circuit 42 may include any appropriate buffers, decoders, video data processors and so forth. The video data may be generated by the control circuit 28, retrieved from a video file that is stored in the memory 22, derived from an incoming video data stream that is received by the radio circuit 34 or obtained by any other suitable method.

The mobile telephone 10 may further include one or more I/O interface(s) 44. The I/O interface(s) 44 may be in the form of typical mobile telephone I/O interfaces and may include one or more electrical connectors. As is typical, the I/O interface(s) 44 may be used to couple the mobile telephone 10 to a battery charger to charge a battery of a power supply unit (PSU) 46 within the mobile telephone 10. In addition, or in the alternative, the I/O interface(s) 44 may serve to connect the mobile telephone 10 to a headset assembly (e.g., a personal handsfree (PHF) device) that has a wired interface with the mobile telephone 10. Further, the I/O interface(s) 44 may serve to connect the mobile telephone 10 to a personal computer or other device via a data cable for the exchange of data. The mobile telephone 10 may receive operating power via the I/O interface(s) 44 when connected to a vehicle power adapter or an electricity outlet power adapter.

The mobile telephone 10 also may include a system clock 48 for clocking the various components of the mobile telephone 10, such as the control circuit 28 and the memory 22.

The mobile telephone 10 also may include a position data receiver 50, such as a global positioning system (GPS) receiver, Galileo satellite system receiver or the like. The position data receiver 50 may be involved in determining the location of the mobile telephone 10.

The mobile telephone 10 also may include a local wireless interface 52, such as an infrared transceiver and/or an RF interface (e.g., a Bluetooth interface), for establishing communication with an accessory, another mobile radio terminal, a computer or another device. For example, the local wireless interface 52 may operatively couple the mobile telephone 10 to a headset assembly (e.g., a PHF device) in an embodiment where the headset assembly has a corresponding wireless interface.

With continuing reference to FIGS. 1 through 3, the camera assembly 12 may include a controller 54, such as a digital signal processor (DSP). In the illustrated embodiment, many control functions of the camera assembly 12 are carried out by the processing device 30. As such, the controller 54 may be downsized relative to a controller 14 found in a dedicated camera device or the controller 54 omitted. In other embodiments of the mobile telephone 10 or when the camera assembly 12 is embodied as a dedicated camera, some or all of the camera assembly 12 control functions that are described as being carried out by the processing device 30 may be carried out by the controller 54.

The processing device 30 and/or the controller 52 controls various aspects of camera assembly 12 operation including, but not limited to, light metering operations and management of exposure settings. The processing device 30 and/or controller 52 also may coordinate storage of image data captured with camera assembly 12. For instance, the image data may be stored by the memory 22 in corresponding image files.

In the illustrated embodiment, the camera assembly 12 is a digital camera that uses a sensor 56 (e.g., a charged-coupled device or CCD) to image a field of view as determined by imaging optics 58 of the camera assembly. A light meter 60 may detect illumination conditions in the field of view. A flash 62 may be present to offer supplemental illumination during taking of a photograph.

With additional reference to FIG. 4, the mobile telephone 10 may be configured to operate as part of a communications system 64. The system 64 may include a communications network 66 having a server 68 (or servers) for managing calls placed by and destined to the mobile telephone 10, transmitting data to the mobile telephone 10 and carrying out any other support functions. The server 68 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 66 may support the communications activity of multiple mobile telephones 10 and other types of end user devices. As will be appreciated, the server 68 may be configured as a typical computer system used to carry out server functions and may include a processor configured to execute software containing logical instructions that embody the functions of the server 68 and a memory to store such software.

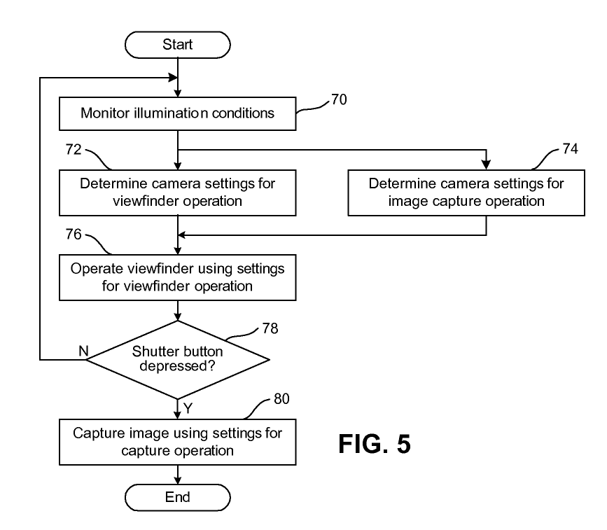

With additional reference to FIG. 5, illustrated are logical operations to implement an exemplary method of viewfinder and image capture operation. The exemplary method may be carried out by executing code with the processing device 30 and/or the controller 54, for example. Thus, the flow chart of FIG. 5 may be thought of as depicting steps of a method carried out by the mobile telephone 10 and/or the camera assembly 12. Although FIG. 5 shows a specific order of executing functional logic blocks, the order of executing the blocks may be changed relative to the order shown. Also, two or more blocks shown in succession may be executed concurrently or with partial concurrence. Certain blocks also may be omitted.

The logical flow for the method of viewfinder and image capture operation may begin in block 70 where illumination conditions in the field of view of the camera assembly 12 may be monitored. In one embodiment, the light meter 60 may detect luminance levels in one or more spots or areas of the field of view. The light meter 60 may generate illumination values or signals that are passed to the processing device 30 or controller 54 for processing.

In one embodiment, the method of viewfinder and image capture operation has application in low light situations. Accordingly, the following description will focus on situations where the luminance of the scene, as detected by the light meter 60, is relatively low. For instance, the method may be carried out for illumination conditions that would indicate the use of image capture exposure settings that would lead to poor viewfinder responsiveness if the same exposure settings were used for viewfinder operation. For situations where greater illumination is present, the method may not be carried out, which may result in using the same exposure settings for both viewfinder operation and for image capture operation.

In another embodiment, the method may be carried out for certain operational modes of the camera assembly 12 and not for other operational modes. Operational modes may be selected by the user or based on sensed conditions. The operational modes may include, but are not limited to, a night mode, a bright light mode, an indoors mode, an outdoors mode, a portrait mode, a sports or action mode, a scenery mode, and a macro mode. In this embodiment, the method may be carried out in the night mode and the indoors mode, but not the remaining modes. In yet another embodiment, the operational mode of the camera assembly 12 and the sensed illumination may be used in combination with each other to determine if the method should be employed or not employed. It will be recognized, however, that the method may be used regardless of the illumination conditions or operational mode of the camera (e.g., the method may be used at all times, in bright light situations or in moderate light situations).

Continuing with the method, following block 70 the logical flow may proceed to each of blocks 72 and 74. Block 72 may be implemented by executing the viewfinder operation function 16 (FIG. 3) and block 74 may be implemented by executing the image capture routine 18 (FIG. 3). In another implementation, the functions of blocks 72 and 74 may be carried by one executable (e.g., the same program).

In block 72, camera settings (also referred to as exposure settings) for operation of the electronic viewfinder may be determined. The camera settings for viewfinder operation may include aperture, exposure time and sensitivity of the sensor 56. In many digital cameras, and especially camera assemblies used as part of mobile telephones, the aperture is fixed. The camera settings for operation of the viewfinder may include setting the exposure time to be short enough to provide for reasonable responsiveness of the viewfinder for corresponding movement of the camera assembly 12 and for movement of objects and persons in the field of the view of the camera assembly 12.

In block 74, and separately from the operation of block 72, camera settings for image capture operation may be determined. The camera settings for image capture operation may include aperture size (if not fixed), exposure time, sensitivity of the sensor 56 and flash 62 operation. The flash 62, if present as part of the camera assembly 12, may be set to be on or off. If set to be on, the flash 62 may emit a pulse of light during the exposure time. In some embodiments, the intensity of the pulse of light and/or the duration of the pulse of light may be controlled.

In block 74, the combination of camera settings may be adjusted to attempt to obtain a quality image that is representative of the scene contained in the field of the view of the camera assembly 12. In one embodiment, the exposure time and the sensitivity of the sensor 56 are optimized for capturing an image. In low light situations, for example, the exposure time may be set to be relatively long so that sensitivity may be kept low enough to minimize the risk of introducing appreciable noise into the image.

In one embodiment, if the luminance of the scene is below a predetermined threshold, the operation of block 74 may adjust the camera settings to activate slow-sync flash operation. For slow-sync flash operation, the flash 62 may be turned on and at least one of the sensor sensitivity or the aperture size may be set to a constant (or fixed) value.

Following blocks 72 and 74, the logical flow may proceed to block 76 where the camera assembly 12 is operated in a viewfinder mode (sometimes referred to as a draft mode) using the camera settings established by block 72. Block 76 may be implemented by executing the viewfinder operation function 16, for example. In the viewfinder mode, the sensor 56 may be used to generate a series of representations of the scene that are displayed on the display 20 to provide the user with an indication of the field of view of the camera 12. During viewfinder operation, it is contemplated that the responsiveness of the viewfinder content may be improved over conventional approaches since the camera settings may be selected in block 72 with an emphasis on viewfinder performance.

Next, in block 78, a determination may be made as to whether the shutter button 26 (FIG. 1) has been depressed. If a negative determination is made in block 78, the logical flow may return to block 70 to continue to monitor the illumination conditions, and generate appropriate camera setting for viewfinder operation and for image capture operation.

If the shutter button 26 is depressed, a positive determination may be made in block 78 and the logical flow may proceed to block 80. In block 80, an image may be captured with the sensor 56 using the camera settings established in block 74. Block 80 may be implemented by executing the image capture routine 18, for example. Capturing the image in block 80 using the camera settings from block 74 may include switching from the camera settings used in block 76 to the camera settings selected in block 74. For at least exposure time and sensitivity of the sensor 56, the switch may be made in a rapid enough manner that little or no delay in capturing the image is introduced. Following block 80, the logical flow may end or may return to block 70 for continued operation of the camera assembly 12.

In an alternative embodiment, the establishment of camera settings for image capture operation (block 74) may be carried out in a period of time between operation of the camera assembly 12 in a viewfinder mode and operation of the camera assembly 12 in a capture mode. For instance, the camera settings for image capture may be determined after the shutter button is depressed (block 78) and before image capture (block 80).

It will be appreciated that the above-described implementation may facilitate the use of autofocus in a night mode or in low light situations. In particular, the autofocus routine may be run as part of block 76 when camera settings for viewfinder operation are used. The responsiveness of the autofocus operation may benefit in similar manner to the responsiveness of the electronic viewfinder operation.

Disclosed has been a camera assembly that separately establishes camera settings for electronic viewfinder operation and for image capture operation. Also disclosed has been a method of separately establishing camera settings for electronic viewfinder operation and image capture operation. Disclosure further is the operation of the camera assembly in a viewfinder mode using the camera settings for the electronic viewfinder operation and, in response to an input command to take a photograph, capturing an image with the camera assembly using the camera settings for the image capture operation.

Although certain embodiments have been shown and described, it is understood that equivalents and modifications will occur to others skilled in the art upon the reading and understanding of this specification. The present invention includes all such equivalents and modifications, and is defined in varying degrees of scope by the following claims.

What is claimed is:

1. A method of operating a camera assembly, comprising:
(a) establishing camera settings for viewfinder operation and displaying a dynamically updated representation of a field of view of the camera assembly by imaging the field of view using the camera settings for viewfinder operation;
(b) establishing separate camera settings for image capture operation; and
(c) in response to an input command to take a photograph, switching from the camera settings for viewfinder operation to the camera settings for image capture operation and capturing an image.

2. The method of claim 1, wherein the camera settings for viewfinder operation are established using a first logical routine and the camera settings for image capture operation are established using a second logical routine that is executed separately from the first logical routine.

3. The method of claim 1, further comprising sensing luminance of at least a portion of the field of view and, if the luminance is less than a predetermined threshold, the camera settings for the image capture operation are established to include at least one of a fixed sensor sensitivity or a fixed aperture setting, and use of a flash.

4. The method of claim 1, further comprising sensing luminance of at least a portion of the field of view and conducting (a) and (b) if the luminance corresponds to a low light situation, otherwise establishing camera settings used for both viewfinder operation and image capture operation.

5. The method of claim 1, wherein (a) and (b) are carried out in a predetermined operational mode of the camera assembly and, for another operational mode of the camera assembly, establishing camera settings used for both viewfinder operation and image capture operation.

6. The method of claim 1, wherein the camera assembly is part of a mobile telephone.

7. The method of claim 1, wherein the camera settings include at least one of exposure time, sensor sensitivity, aperture size or flash operation.

8. A program for operating a camera assembly that is stored by a machine readable medium, the program comprising:
code that forms a first logical routine that, when executed, establishes camera settings for viewfinder operation; and
code that forms a second logical routine separately executable from the first logical routine and that, when executed, establishes camera settings for image capture operation.

9. The program of claim 8, further comprising:
code that controls the camera assembly to display a dynamically updated representation of a field of view of the camera assembly by imaging the field of view using the camera settings for viewfinder operation; and
code that controls the camera assembly to capture an image using the camera settings for image capture operation in response to an input command to take a photograph.

10. The program of claim 8, wherein if sensed luminance of at least a portion of the field of view is less than a predetermined threshold, the second logical routine establishes camera settings for the image capture operation to include at least one of a fixed sensor sensitivity or a fixed aperture setting, and use of a flash.

11. The program of claim 8, wherein the first and second logical routines are executed when a sensed luminance of at least a portion of the field of view corresponds to a low light situation, otherwise code that establishes camera settings used for both viewfinder operation and image capture operation is executed.

12. The program of claim 8, wherein the first and second logical routines are executed when the camera assembly is in a predetermined operational mode and, for another operational mode of the camera assembly, code that establishes camera settings used for both viewfinder operation and image capture operation is executed.

13. The program of claim 8, wherein the camera assembly is part of a mobile telephone.

14. The program of claim 8, wherein the camera settings include at least one of exposure time, sensor sensitivity, aperture size or flash operation.

15. A camera assembly, comprising:
a sensor for imaging a portion of a scene falling within a field of view of the camera assembly;
a light meter for determining luminance of at least a portion of the field of view;
an electronic viewfinder that displays a dynamically updated representation of the field of view as detected by the sensor; and
a controller that sets at least one camera setting for use in capturing the representation of the field of view for display by the electronic viewfinder and that changes the camera setting to capture an image of the field of view in response to an input command to take a photograph.

16. The camera assembly of claim 15, wherein the camera setting for viewfinder operation is established using a first logical routine executed by the controller and the camera setting for image capture is established using a second logical routine that is executed by the controller separately from the first logical routine.

17. The camera assembly of claim 15, wherein the camera settings include at least one of exposure time, sensor sensitivity, aperture size or flash operation.

18. The camera assembly of claim 15, further including a flash, wherein the controller activates the flash and fixes at least one of sensor sensitivity or aperture size for image capture when the sensed luminance is less than a predetermined threshold.

19. A mobile telephone, comprising the camera assembly of claim 15 and call circuitry for establishing a call over a network.
